(19) United States
(12) Patent Application Publication
(10) Pub. No.: US 2002/0121239 A1
(43) Pub. Date: Sep. 5, 2002

(54) Devices and methods for applying liquid coatings to substrates

(76) Inventors: Juan C. Lopez Tonazzi, Tucson, AZ (US); Raymond Zhang, Tucson, AZ (US); Robert S. LeCompte, Tucson, AZ (US)

Correspondence Address: FITZPATRICK CELLA HARPER & SCINTO, 30 ROCKEFELLER PLAZA, NEW YORK, NY, 10112, US

(21) Appl. No.: 10/136,074

(22) Filed: Apr. 29, 2002

Related U.S. Application Data
(63) Continuation of application No. 08/831,667, filed on Apr. 9, 1997, now abandoned.
(60) Provisional application No. 60/015,226, filed on Apr. 10, 1996.

(51) Int. Cl. B05C 1/00

(52) U.S. Cl. 118/401; 118/244

(57) ABSTRACT

Liquid film dies for coating of substrates with thin films of fluid have substantially constant fluid path geometry fluid passages leading to fluid outlet orifices. A fluid film applicator for applying a film of a fluid onto a substrate includes a dispensing head which dispenses the fluid so that the fluid is deposited as a continuous sheet on the substrate, and a meniscus forming member that controls the thickness of the fluid in the continuous sheet. The dispensing head may include upper and lower plates with a fluid channel between, the plates being offset and positioned relative to the meniscus former. A variable contour dispensing head has movable dispensers which feed coating fluid to a common slot, and the slot can be deformed to correspond to the shape of the surface being coated.

This invention claims the benefit of U.S. Provisional Application No. 60/015,226, filed Apr. 10, 1996.

This invention was made in part with government support under grant no. DE-FC36-95G010069 awarded by the Department of Energy. The United States government has certain rights in the invention.

### BACKGROUND OF THE INVENTION

1. Field of the Invention

This invention involves both apparatuses and methods for applying fluid coatings, such as liquid precursors, to substrates. More specifically, the present invention involves techniques for applying regular, thin, optical quality coatings of low viscosity liquids to solid substrates, both flat and curved.

2. Description of the Related Art

Sol-gel or wet chemical technology is being used in an ever-increasing manner to provide coatings of materials for many diverse applications. For example, coatings may be applied to provide the substrate with a layer having a desired quality, such as optical, electrical, electro-optical or magneto-optical properties, corrosion resistance, scratch resistance, barrier layers, anti-fogging, anti-reflection and other properties. Typically in this method a substrate is coated and then subjected to at least one of elevated temperature, humidity, pressure, chemical reduction, chemical oxidation, basic or acidic atmospheres for the development of the desired coating attributes. One of the advantages of using liquid precursors is that it allows the use of inexpensive capital equipment, in contrast to other methods such as physical vapor deposition. This advantage becomes more noticeable with increasing substrate area and coating thickness. Another benefit of a sol-gel process is that multiple cation-based coatings of inorganic oxides can be used without any cost penalty.

Thus, there is considerable interest in developing new coating devices and methods which coat substrates with greater accuracy and less waste.

A variety of different methods have been proposed in the art for coating thin films of liquid precursors onto substrates, such as dip coating, spin coating, slot coating, meniscus coating, roller coating, curtain coating, draw bar coating and spraying. Overviews of these known techniques can be found in Modern Coating and Drying Technology, by Cohen, et al., Thin Film Coating, by Benkira, ed., and Coating and Drying Defects, by Gutoff, et al. Methods such as dip coating, spin coating and spraying use, however, too much precursor when coating a specific substrate area. This decreases the cost effectiveness of the process because of excess chemical waste disposal and the precursor loss.

In dip systems, waste of the coating fluid is inevitable because a large bath of liquid precursor is required, and this bath has to be periodically replaced as the precursor degrades.

Curtain coating and draw bar coating (including draw bars with wire-winding) are suitable for high-viscosity liquids.

Typically, slot coating and roller coating (e.g., Gravure) techniques are used for highly flexible substrates, i.e., webs of material.

In contrast to many prior art coating techniques, the present invention is suitable for coating liquids having lower viscosities, which means viscosities typically lower than 0.1 P (poise). In particular, this invention can be employed with liquids having viscosities within the range of approximately 0.001 P to approximately 1 P, and more preferredly, within the range of approximately 0.01 P to approximately 0.1 P.

Slot and meniscus coating methods can be used to coat large areas with uniform coatings. Known meniscus systems need large reservoirs of liquid which is recirculated to keep the meniscus optimal. If the rheological properties of the liquid change with age, for example, because of liquid degradation, the consistency of the meniscus, coating thickness and properties will be difficult to control. Thus, large batches of precursor fluids may have to be periodically discarded, reducing the efficiency of precursor utilization.

One of the-known types of devices used to coat substrates is the slot coater, shown in FIG. 1A. It is understood that such devices can be used to apply liquids having viscosities of about 0.1 P to about 10 P, with viscosities above 0.1 P being preferred. Such devices apply a thin film of coating liquid 1 to a substrate 4 by guiding the liquid from a liquid source (not shown) along a tube 2 to a fluid inlet orifice 11 of a die 3, which has a linear opening (a slot) 5. A suitably-contoured internal chamber leads the fluid from the fluid inlet orifice to the slot 5. Liquid 1 flowing out of the die 3 forms a regular coating of fluid on the substrate 4 by virtue of downstream meniscus 6. Owing to the complexities of fluid flow, it can be difficult to design a die having an internal chamber (not shown) leading from the liquid source to the linear opening shaped to facilitate such liquid flow. Various examples of such internal chamber configurations are discussed by Michaeli et al. in Extrusion Dies for Plastic and Rubber.

Attempts have been made to improve fluid flow properties for coating fluids being applied to substrates from slot coaters. Such attempts have involved varying the slot length from the feed tube 2 in the dispensing head to the die lips surrounding the slot, for example, by contouring the internal chamber (not shown) within the die. Such internally-contoured die assemblies are known as coat-hanger dies, fishtail dies, T-dies, etc, and examples of such die designs are shown in FIGS. 1A through 1D and 1F. In each such configuration, there is a minimum average slot length that will meet the uniform flow specifications. The art also teaches that thermoplastic extrusion manifolds can be constructed such that the distribution channel and land region have equal resistances to flow on each flow path. As shown in FIG. 1G, this can be done by vertically elevating each flow path to such an extent as to compensate for its position along the slit, the center being higher than the edges. This means that different fluid paths are of different lengths, the end paths being shorter than those in the center. This die design has several advantages. Since all of the path lengths from each of the dispensing points are geometrically equivalent, the die design does not have to be changed should any changes occur in the fluid parameters. For example if viscosity, dependence of viscosity on shear rate (e.g., the viscosity index in non-Newtonian fluids) or other parameters change, the flow paths are still equivalent. Such dies are, however, fairly large in size. Moreover, the vertical elevation of certain fluid paths means that the dies do not lie in a plane, and this is a real impediment to the use of those dies in modern production equipment, since such dies are expensive to machine, and since space can be quite limited.

FIG. 1E depicts a manifold system used in plastic molding. Molten plastic flows through a number of fluid paths to molds, and all of those fluid paths have equal lengths.

Thus, there exists a genuine need for coating technology which allows the application to a substrate of a uniform thin coating of low-viscosity liquid, while avoiding waste of the coating liquid.

Furthermore, there is a need for a coating technology which enables the application of a uniform thin coating of low viscosity liquid on a curved substrate, and especially a compound curved substrate.

While it is clearly desirable to be able to apply regular thin coatings of low viscosity liquids such as chemical precursors to substrates, none of the prior art coating techniques has proven satisfactory. Thus, there is a clear need for coating technique which can coat in the manner desired.

As discussed below, the design of fluid dispensing heads according to the present invention offers several advantages over the conventional coating methods, in particular, slot coating. In addition, none of these techniques have been adapted for coating curved substrates, in particular, those having a compound curvature. The invention described here overcomes all the above discussed problems for coating operation in a cost effective way.

The equipment described in this invention makes optimum use of the precursor, which in turn further enhances the cost-effectiveness of the sol-gel or the wet-chemical process. In a manufacturing environment smaller quantities of precursor could be produced and automatically fed into the coating equipment, creating a lean and efficient process.

### SUMMARY OF THE INVENTION

An object of the present invention is to coat liquid precursors of low viscosity onto large area rigid substrates with excellent uniformity and near complete utilization of the coating precursor so as to reduce waste.

A further object of the present invention is to apply in a regular, controlled manner thin coatings of low viscosity liquids onto substrates.

Still a further object of the present invention is to provide a liquid film die in which all fluid flow paths within that die have substantially equal fluid path geometries.

Yet another object of the present invention is to provide an improved liquid film die of the type used in slot coaters.

An object of the present invention is to provide a liquid film die having a body which includes a slot, fluid inlet orifice, fluid outlet orifices communicating with the slot, and fluid passages leading from the fluid inlet orifice through the body to the fluid outlet orifices. The passages define fluid paths, and each fluid path has a fluid path geometry and leads from the fluid inlet orifice to an associated fluid outlet orifice. All of the fluid path geometries of the fluid paths are substantially equal.

Another object of this invention is to provide a liquid film die which has a first member that includes a recess, a fluid inlet orifice, fluid outlet openings communicating with the recess, and fluid channels leading from the fluid inlet orifice to the fluid outlet openings. A second member is joined to the first member so that the fluid channels define fluid paths, and each fluid path has a fluid path geometry and leads from the fluid inlet orifice to an associated fluid outlet opening. All of the fluid path geometries of the fluid paths are substantially equal, and when the first and second members are joined, they define a slot and fluid orifices.

Another object of this invention is to provide a liquid film die that includes a first member having a fluid inlet orifice, plural fluid outlet openings, and plural fluid channels leading from the fluid inlet orifice to the fluid outlet openings. A second member is joined to the first member so that the fluid channels define fluid paths thereby, each fluid path having a fluid path geometry and leading from the fluid inlet orifice to an associated fluid outlet opening. All of the fluid path geometries are substantially equal, and when the first and second members are joined, they define plural fluid orifices.

Still another object of the invention is the provision of a liquid film die made from a first member having a first recess, a fluid inlet orifice, first fluid outlet openings communicating with the first recess, and first fluid channels leading from the fluid inlet orifice to the first fluid outlet openings. The die also includes a second member having a second recess, second fluid outlet openings communicating with the second recess, and second fluid channels leading from the second fluid inlet orifice to the second fluid outlet openings. The second member is joined to the first member in a manner such that the first and second recesses, first and second fluid outlet openings, and first and second fluid channels all are in registry with one another, thereby defining fluid paths. Each fluid path has a fluid path geometry and leads from the first fluid inlet opening, to associated first and second fluid outlet openings, which are in registry, and provides for fluid communication therebetween. All of the fluid path geometries are substantially equal. When the first and second members are joined, the recesses define a slot, and the openings define fluid orifices.

In addition, the instant invention pertains to a liquid film die, which includes a first member with a fluid inlet orifice, plural first fluid outlet openings, plural first fluid channels leading from the fluid inlet orifice to the first fluid outlet openings, and a second member that has plural second fluid outlet openings, and plural second fluid channels leading from a point to the second fluid outlet openings. The second member is joined to the first member in a manner such that the first and second fluid outlet openings and first and second fluid channels all are in registry and thereby define a plurality of fluid paths. The fluid paths are in registry, and each fluid path has a fluid path geometry which leads from the fluid inlet orifice to associated first and second fluid outlet openings, which openings are in registry so as to define a plurality of fluid orifices, thus providing for fluid communication therebetween. All of the fluid path geometries are substantially equal.

The instant invention also has as an object a fluid distribution process for applying a film of fluid to a substrate by providing a source of fluid, providing a number of fluid outlets and a slot-shaped landing area which are dimensioned and disposed so that when fluid flows therefrom the fluid flows as a continuous film, and dividing, a number of times, the fluid coming from the source, to obtain a series of divided flows, equal in amount to the number of fluid outlets. Each divided flow has a flow geometry, and the flow geometries all are substantially equal. The divided flows are guided to the fluid outlets to form the continuous film.

Moreover, this invention involves a fluid film applicator for applying a film of fluid onto a substrate, and this applicator contains a dispensing die which dispenses fluid so that the fluid is deposited as a continuous sheet on the substrate, and a meniscus forming member that controls the thickness of the fluid in the continuous sheet, so as to form the film.

This invention also relates to the provision of a fluid film applicator for applying a film of fluid onto a substrate, the applicator and substrate having relative motion therebetween, and this applicator includes a dispensing head having a dispensing die which dispenses fluid so that the fluid is deposited as a continuous sheet on the substrate along a line, as well as a meniscus forming rod having an axis approximately parallel to the line. The meniscus forming member is disposed proximate to the dispensing head. Fluid dispensed from the dispensing die forms an upstream meniscus and a downstream meniscus relative to the relative motion between the substrate and fluid film applicator.

Yet another aspect of this invention is a fluid distribution process for applying a film of fluid to a substrate, by providing a source of fluid, providing a number of fluid outlets dimensioned and disposed so that when fluid flows therefrom the fluid eventually flows as a continuous film, dividing, a number of times, the fluid coming from the source, to obtain a series of divided flows, equal in amount to the number of fluid outlets, each divided flow having a flow geometry. The flow geometries all are substantially equal. The process also includes guiding the divided flows and forming a meniscus of fluid in order to control the film which is applied to the substrate.

Moreover, this invention relates to a fluid film applicator for applying a film of a fluid onto a substrate, when there is relative motion between the applicator and substrate, and this applicator includes a dispensing die which dispenses fluid so that the fluid is deposited as a continuous film along a line, which dispensing die has an upper plate having a first edge, a lower plate having a second edge, the upper and lower plates being separated so as to define a fluid channel therebetween. The first edge is offset backward from the second edge relative to a direction in which the fluid flows, and the fluid flows through the channel and emerges along the line. In addition, the applicator contains a liquid film die that includes a fluid inlet orifice, fluid outlet orifices communicating with the channel, and fluid passages leading from the fluid inlet orifice to the fluid outlet orifices, and defining fluid paths thereby. Each fluid path has a fluid path geometry and leads from the fluid inlet orifice to an associated fluid outlet orifice, so that all of the fluid path geometries are substantially equal. A meniscus forming rod has an axis approximately parallel to the line, and the meniscus forming member is disposed proximate to the dispensing die. Thus, fluid dispensed from the dispensing head forms an upstream meniscus and a downstream meniscus relative to the relative motion between the substrate and the fluid film applicator.

This invention also pertains to a liquid film die having a reference body, a channel member having a groove, and fluid dispensers for dispensing a coating fluid into the groove. The fluid dispensers are connected to one another by flexible sections. Several actuators are provided in a number that corresponds up to that of the fluid dispensers. The fluid dispensers are connected to the reference body by associated actuators, which can move the fluid dispensers, thereby altering the shape of the groove.

Still other aspects of this invention pertain to the provision of fluid passages in a plane, the disposition of fluid outlet orifices on either straight or curved lines, and use of a slot which is either a straight or a curved line.

In addition, the die can have a width, and the fluid passages consist of transverse legs running approximately parallel to the width, as well as advance legs, the transverse legs being approximately perpendicular to the advance legs.

The meniscus forming rod used in this invention can be either a wire-wound rod or a smooth rod, and the rod may rotate about the axis.

A dispensing die according to this invention can include an upper plate having a first edge and a lower plate having a second edge, the upper plate being separated from the lower plate so as to define a fluid channel therebetween. The first edge can be offset from the second edge along a direction in which the fluid flows as the fluid flows through the channel and emerges along a line.

### BRIEF DESCRIPTION OF THE DRAWINGS

FIG. 1A is a side cross-sectional view of a slot coating head of a type known in the art, and

FIGS. 1B-1D and 1F depict known internal die configurations.

FIG. 1E shows a plastic molding manifold, and

FIG. 1G depicts a flat slit manifold having streamlines (flowpaths) which are of equal length.

FIG. 2A is a schematic side view of one embodiment of the claimed invention.

FIG. 2B is a simplified schematic view of another embodiment of the claimed invention in which the die is positioned with a vertical orientation.

FIG. 3 is a front elevational view of the wire wound rod shown in FIG. 2A.

FIGS. 4A and 4B are a top plan view and a front elevational view, respectively, of a coater assembly according to the claimed invention.

FIG. 5B is a side cross-sectional view as taken along line 5B-5B of FIG. 4A.

FIG. 5A is a top plan view of the lower plate of the coater assembly shown in FIGS. 4A and 4B.

FIG. 5B is a side cross-sectional view as taken along line 5B-5B of FIG. 4A.

FIG. 6A is a top plan view of another embodiment of a coating apparatus according to the present invention, and

FIG. 6B is a top plan view of the lower plate of the coater die assembly shown in FIG. 6A.

FIG. 6C is a close-up view of a portion of FIG. 6B.

FIG. 7A is a side cross-sectional view of the tip of the coater assembly.

FIG. 7B is a close-up side cross-sectional view of the tip of the coater assembly.

FIG. 8A is a top plan view, and

FIG. 8B is a side cross-sectional view taken along lines 8B-8B thereof, of another embodiment of a coating apparatus according to the present invention.

FIG. 9A is a top plan view of a further embodiment of a coating apparatus according to the present invention, and

FIG. 9B is a top plan view of the lower plate of the coater shown in FIG. 9A.

FIG. 9C is a side cross-sectional view showing an internal structure of the embodiment depicted in FIGS. 9A and 9B.

FIG. 10 is a side cross-sectional view of another embodiment of the flexible coating head.

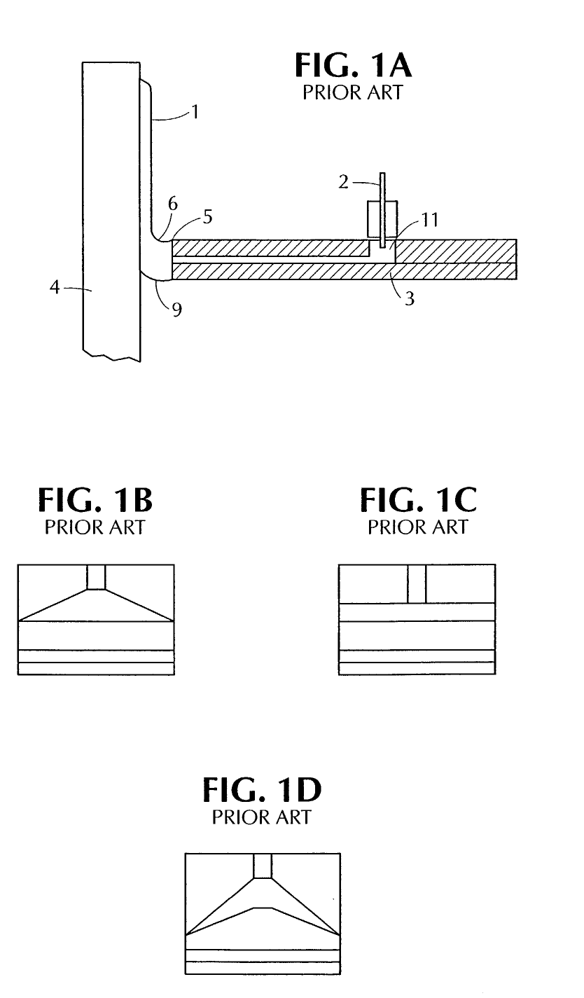

### DESCRIPTION OF THE PREFERRED EMBODIMENTS

The examples which follow are intended as illustrations of certain preferred embodiments of the invention, and no limitation of the invention is implied thereby.

The terms “fluid” and “liquid” are used in the broadest sense possible. These terms therefore should not be construed as requiring the use or presence of any particular material, or to otherwise limit the scope of this invention.

This invention can be used to apply polymeric coatings, such as those described in U.S. patent application Ser. No. 08/330,090, U.S. patent application Ser. No. 08/547,578, and U.S. Provisional Patent Appln. No. 60/015,223, entitled “Electrochromic Devices”, the disclosures of which are all incorporated by reference as if fully set forth herein. The present invention is particularly useful for coating substrates with low viscosity fluids, such as those typically used in sol-gel or wet chemical technology. The viscosity of such liquids is typically below 0.1 poise (P) at room temperature and is preferably below 0.01 P. Many of these liquids have organic solvents, particularly alcohol, as a major constituent, e.g., methanol, ethanol, etc. These solvents may constitute more than 25% by volume of the coating precursor, and preferably are more than 50% of that coating precursor. Examples of such coating fluids can be found in Sol-Gel Science by Brinker, et al. Specific examples can also be found in U.S. Pat. Nos. 4,959,247,

4,996,083, 5,252,354, 5,277,986, 5,457,218 and U.S. patent application Ser. No. 08/386,771, the disclosure of all these patents and application being incorporated by reference as if fully set forth herein.

It is preferable for a coating precursor to have low surface tension, so that the liquid can spread out easily. A precursor having any surface tension that will allow the liquid to spread sufficiently could be used, and it is preferable that the surface tension be less than 50 dynes/cm, and even more preferable that the surface tension be less than 40 dynes/cm. As described hereinafter, the ability to apply fluids having low viscosities and low surface tensions was important in developing this invention.

In developing devices for uniformly coating rigid substrates according to the present invention, four important issues were kept in mind. First, it was necessary to provide a structure for dispensing the liquid over the width of the substrate. This dispensing should be accomplished evenly and at a controlled rate. Second, a way to form and control a meniscus on the substrate was required. The meniscus has to be kept unchanged in shape in order to form a uniform coating on the substrate. Third, it was necessary to provide for relative motion between both the dispensing die and meniscus former relative to the substrate to be coated. Finally, the coating has to be dried.

In addition, the coating can be subjected to further processing, such as by treatment at elevated temperature, humidity, etc.

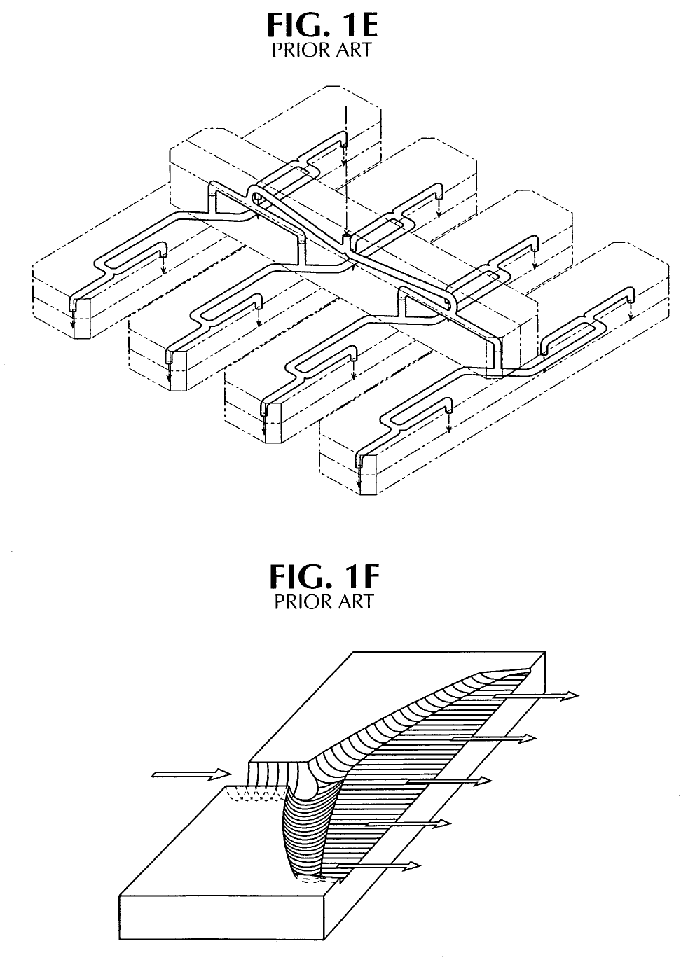

One embodiment of the present invention involves a mechanism for dispensing a coating liquid. As shown in FIG. 2A, that dispensing mechanism consists of a fluid carrying assembly 14 and an applicator 16 that evenly dispenses the fluid onto a substrate 29. The fluid carrying assembly 14 can consist, for example, of a fluid (coating precursor) containing vessel 15, pump 17, filter 19 and dispensing die 21, as well as a de-gasser (not shown), temperature conditioner (not shown), damper (not shown), on-line mixer (not shown) and viscosity and/or flow monitors.

Regulating meniscus formation is an important factor in controlling the quality, thickness, etc. of the coatings. Dispensing of fluid onto the substrate can occur directly, or the fluid can be dispensed indirectly onto the substrate via a meniscus former. In order to provide a more even coating, it is preferable to control the film being applied by using the meniscus former, which controls the film by way of the meniscus pools located on both sides thereof. Those pools can also provide a buffer to overcome temporal and positional unevenness in dispensing, or variations in substrate smoothness.

For coatings which are deposited onto a substrate 29 placed horizontally on a coater table 31 of the machine, the preferred technique is to dispense fluid uniformly from the dispensing die 21 onto the meniscus former 25. The meniscus former can be a rod, wire wound rod, or a blade, such as a doctor blade, which preferably runs across the entire width of the substrate 29. The meniscus former 25 can be in contact with or separated slightly from the substrate 29, typically by a few mils (0.001″), within the range of about 0.001″-0.01″. The meniscus former and the dispenser die 21 can be separate components, or could be part of a single unit. It is thought to be preferable to have them as separately mounted components, so that they can be adjusted independently relative to the substrate, facilitating the use of a variety of different coating fluids having different fluid properties.

Three fluid properties are believed to be of particular importance in applying liquid coatings, namely, the temperature of the coating liquid, liquid viscosity and surface tension. The latter two properties are in fact dependent upon liquid temperature. Thus, it is contemplated that the temperature of the die itself could be regulated so as to control the coating liquid temperature, thereby also controlling viscosity and surface tension. In some cases, the temperature of the substrate may also need to be controlled.

For coatings which are deposited when the substrate is held vertically, the preferred method is to design the die in such a way that it forms a stable meniscus on the substrate. It is also possible to coat curved substrates by using a curved dispenser/meniscus former which conforms to the substrate curvature, as discussed in greater detail below.

Either or both substrate 29 and the meniscus former 25, along with the dispensing die 21, can be moved to convert the pool of fluid forming the meniscus 23 into a coating 27. A preferred method is to move either the substrate 29 or both the meniscus former 25 and the dispenser 21. For a device in which the substrate is oriented horizontally, the most preferred method of application involves moving the substrate. For a device in which the substrate is held vertically, the most preferred method is to move the dispensing head 3. If the substrate is not flat (that is, the substrate is curved), it may be preferable to move both the dispensing head and the substrate, so that the meniscus 1 is kept horizontal and of approximately constant size throughout the coating process.

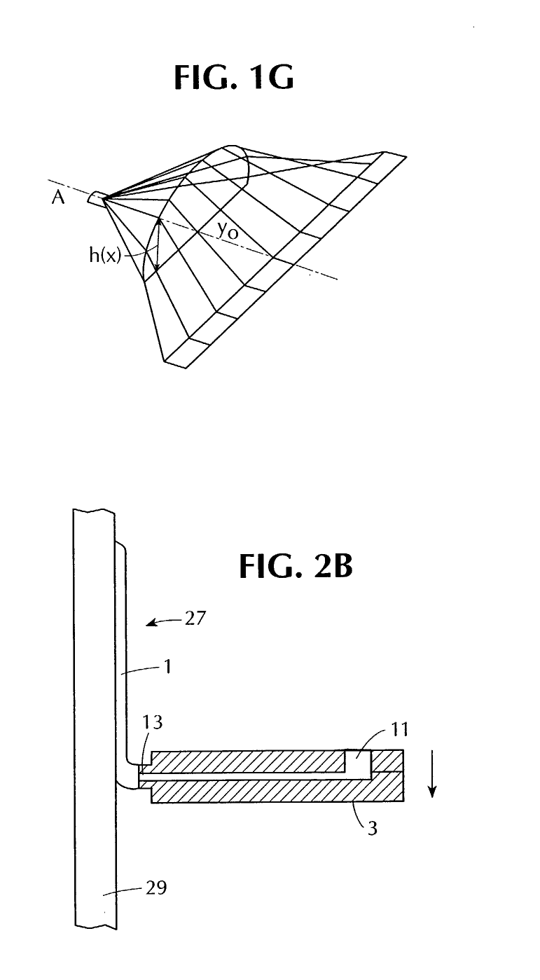

The above described head according to this invention can be used to form coating 27 directly on substrate 29. When coatings are to be deposited on horizontally oriented substrates, it is preferred to dispense the liquid onto a meniscus former 25. The meniscus former can be a rod, such as a circular rod, that spans at least the width of the surface to be coated. This is also close to the width of the dispenser head. As shown in FIG. 3, one preferred meniscus former has a circular rod geometry and could either be in contact with the substrate 29 or be slightly raised from the substrate, leaving a uniform gap to regulate coating thickness. In those cases where the rod 25 touches the surface, it is preferred for the rod to have a tight wire winding 33 wrapped around a smooth round core 35. It is preferred that the wrapping wire cross-section be circular, and have a diameter of less than 0.02 inches. If the meniscus former 25 is separated by a small gap from the substrate 29, a smooth rod may be preferred, since it is easier to clean up smooth surfaces.

Satisfactory results have been obtained using a stainless steel rod ½″ in diameter with a 16″ width. It is also contemplated that other materials such as steel rods coated with a non-reactive material, such as polytetrafluouroethylene (TEFLON®) could be used. Such rods are available from Industry Tech of Oldsmar, Fla.

A typical gap could be 0.003″, with a preferred range of 0.01″-0.001″, but of course other gaps could be used without departing from the spirit and scope of this invention. Wet films having a thickness of 1000 Å to 10 μm have been obtained, which result in dried film thicknesses of 100 Å to 1 μm.

The coating 27 can be dried by employing any of the following methods. For example, a constant flow of air or other gas such as nitrogen could be blown onto the coating to provide the desired properties and the uniformity. Drying may be assisted by applying external heat or radiation (i.e, infrared, ultraviolet, microwave energy, etc.) from dryer 18. It may be desirable to initiate the drying process after the liquid coating has been allowed to reach an equilibrium condition. During this period, or in the drying period, reactive gases such as those which are acidic or basic in nature may also be introduced. These gases could also be recirculated and organics contained therein stripped off for recycling or further processing. The coatings can then be stored under proper conditions for subsequent processing or be processed further in line with the coater. Such post deposition processing may include subjecting coatings to elevated temperature, radiation and humidity, etc.

In contrast to FIG. 2A, which shows an embodiment of the claimed invention as just described, and which is meant to coat a substrate held in a horizontal orientation, FIG. 2B depicts an embodiment of the invention for coating a substrate held in a vertical orientation for coating. It will be appreciated that in the interests of simplification, parts corresponding to parts shown in FIG. 2A have been identified using like numbering.

Among the advantages of the non-contact method of coating using a meniscus former is that it avoids scratching fragile surfaces. Such fragile surfaces can include polymeric substrates or substrates that may have fragile coatings which were deposited earlier. Additionally, with the non-contact method one could mask (with tape or other protective layers) those areas of the substrates that are not to be coated.

Once the fluid has been dispensed onto the meniscus former 25, which is typically rod-shaped, capillary action and surface tension force some of the fluid beneath the rod, thereby establishing a meniscus 23 on both the sides of the rod. The total amount of the fluid initially dispensed determines the shape of the initial meniscus. When the substrate is moved in direction v as shown in FIG. 2A, some of the fluid from the front meniscus 23a is dragged therewith, forming the coating 27. Depletion of the coating liquid is avoided by continuously replenishing fluid, this fluid being introduced by the dispenser die 21 onto the back of the rod.

The shape of the meniscus 23 is an important factor in controlling the film thickness. For coating uniformity and to avoid fluid overflow, it is important to keep the rate of coating fluid consumption and the replacement of coating fluid replacement the same, so that meniscus size remains approximately constant. This can be done by adjusting various machine parameters, such as rate of substrate movement, fluid feed rate, meniscus former/substrate separation, etc.

As an example, a coating solution containing 0.3 grams of solids per milliliter of ethanol with a viscosity of 4 centipoise was used to coat a glass substrate that was 14″ wide. The substrate was moved at a rate of 0.2″/second, and during the coating operation, fluid was dispensed at the rate of 1 milliliter/minute. The gap between the meniscus former and the substrate was 0.003″. After air drying, the thickness of the coating was 0.7 μm.

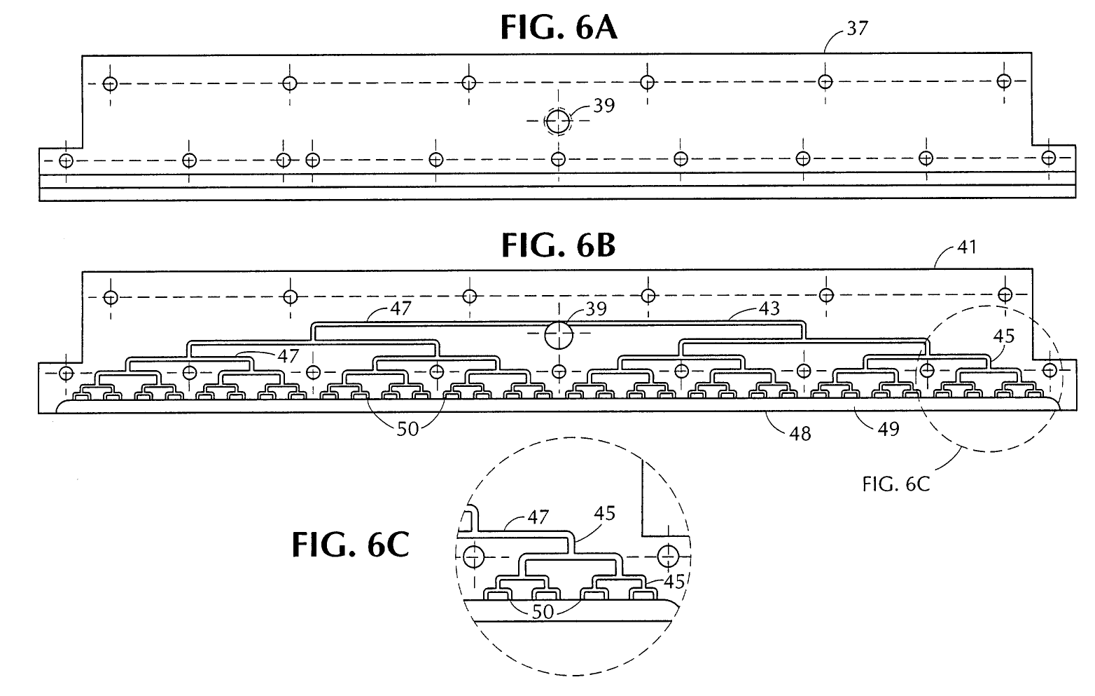

The placement of the meniscus former 25 in relation to the tip of the dispensing die 21 has been found to be an important parameter to control the coating's uniformity. The die 21 should feed fluid out at a position close to the meniscus former 25. As shown in FIG. 7A, the feed point should preferably be located in the space between the substrate 29 and the lower half of the cylindrical meniscus former.

For example, as shown in FIG. 7B, θ=30°, x=0.1″, and y=0.0015″. The diameter of rod 25 was ½″. It will be appreciated that these dimensions could vary when other solutions or different diameter rods are used, or different coating thicknesses are desired. One source of these coating rods is Industry Tech, located in Oldsmar, Fla.

The cylindrical meniscus formed can be either a wire wound rod, as shown in FIG. 3, or a smooth rod. As shown in FIG. 7A, the distance between the dispensing lips 57 and 59 of the die and the meniscus former should be such so that the surface tension of the fluid continuously bridges this gap. The lip design and the die geometry should be such so that all these constraints are met and the fluid is continuously transferred to the meniscus former 25 without dripping. One preferred design that meets these constraints, and which is shown in FIG. 7A, consists of a set of wedge-shaped lips 57, 59 which can closely approach and so feed coating fluid to the meniscus former 25, while also coming close to the substrate. In addition, it has been found preferable for the lower lip 57 to extend out further than the upper lip 59, as shown, to facilitate the transfer of coating liquid to the meniscus former. It is believed that an offset O of 0.005 inch to 0.03 inch is preferred when using a 0.5 inch diameter meniscus forming rod.

As mentioned previously, the design of the dispensing die 21, type of meniscus former 25 and the positioning of the meniscus former relative to the die is critical to coating the fluid 27 uniformly over the substrate 29. Examples of preferred die constructions will now be discussed.

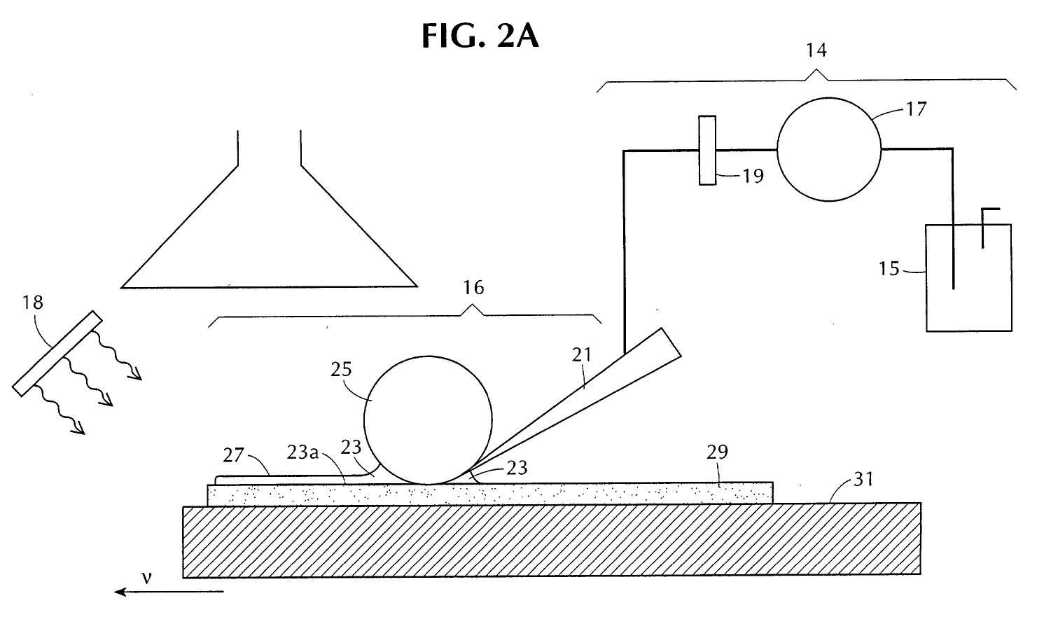

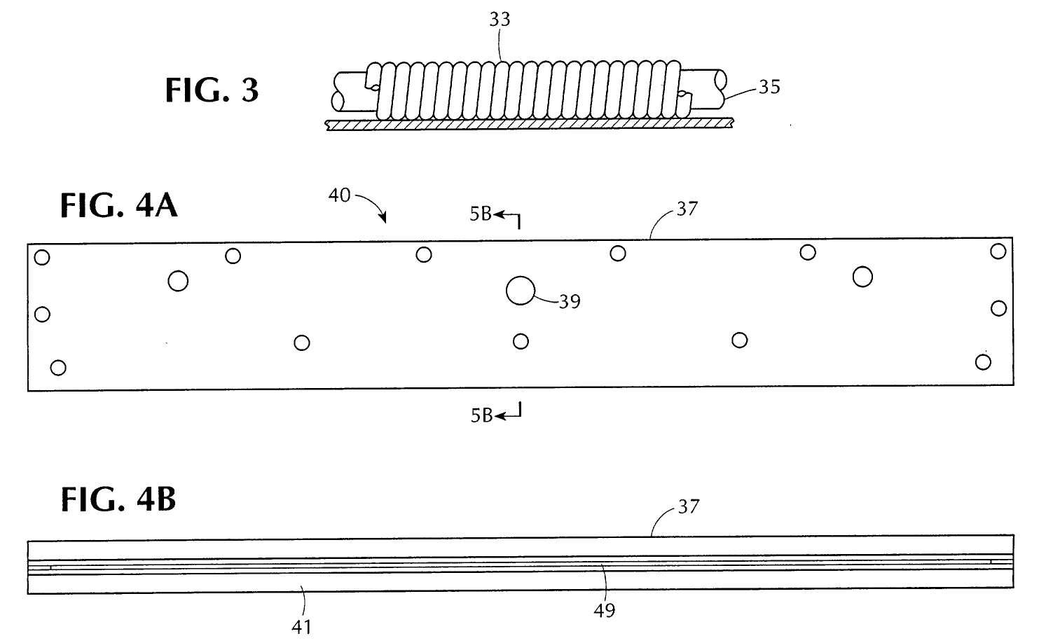

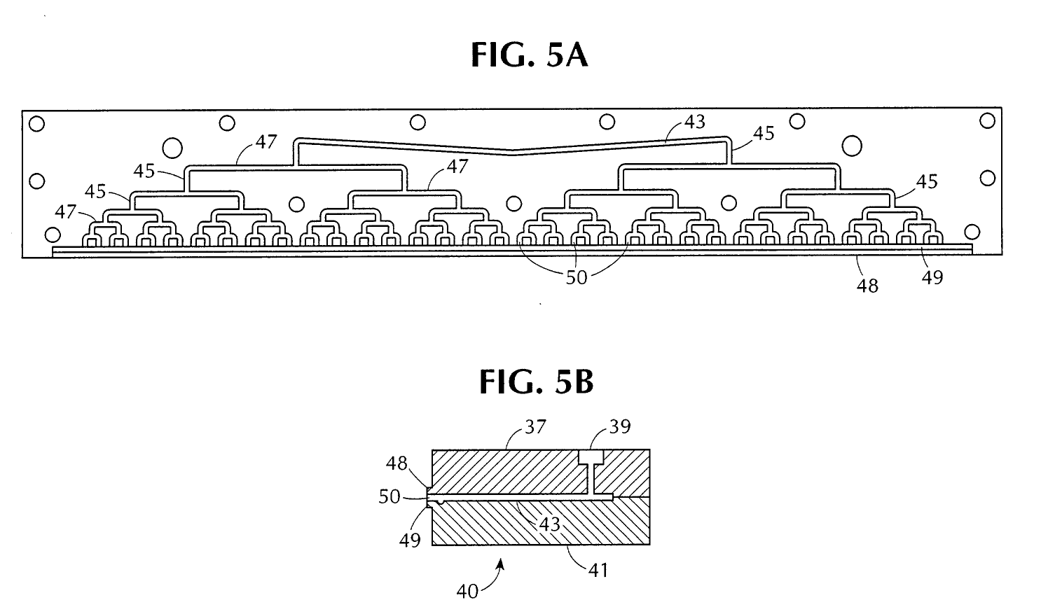

Dispensing die assembly 40, shown in FIGS. 4A, 4B, 5A and 5B, can uniformly distribute fluid over the width of the substrate. Incoming fluid is introduced into the die 40 at a fluid inlet orifice 39 and is then uniformly distributed through a pattern of branching fluid passages 43 that ultimately dispense the fluid through fluid outlet orifices 50 into a slot-shaped landing zone 49 located by the lip 48 of the die. To ensure uniformity, the pattern is geometrically designed so that the distance and the pattern that the fluid travels along any fluid path from the fluid inlet orifice 39 to each of the fluid outlet orifices 50 is the same. Thus, all of the fluid flow paths are of substantially equal length, and have equivalent geometries, meaning that the paths all have the same number and types of turns. These equivalent geometries therefor provide for a number of fluid paths which have the same fluid impedances, which improves fluid flow uniformity along the width of the die. Any pattern shape could be used that satisfies the above-mentioned conditions, and preferably each of the fluid paths has the same geometric length, depth, width and number of turns, so that the fluid paths all have the same fluid path geometries. The branched fluid passages consist of both advance legs 45 and transverse legs 47, which are shown as being approximately perpendicular to one another (of course, other configurations could be used). Another pattern is shown in FIGS. 6A-C, where the fluid passages become narrower in size as they come closer to the dispensing points. This configuration insures that the pressure drop in the channels, and hence the dispensing, is similar. For example, when using the solution previously described, semicircular grooves of diameter about 0.05″ were milled in a plate of material that formed one half of the die, and each fluid path had a length of about 7.25″. About 64 outlet orifices were provided across the face of a 14″ die, giving a center-to-center pitch of about 0.18″. The semicircular grooves were then closed to form channels when the plate of material was covered by a flat plate forming the other part of the die.

If desired, the pattern of fluid paths could be engraved only in the bottom half 41 of the die, and a flat mating cover 37 (or bottom) could then be used. It is thought to be preferable to make the die using a noncorrosive or non-reactive material such as stainless steel or plastic. Alternatively, other materials could be used provided a suitable layer of protective material, such as polytetrafluouroethylene (such as TEFLON®) or plated metal is formed on the fluid paths and other areas coming into contact with the coating fluid.

The distance between adjacent fluid outlet orifices 50 where the fluid exits the die 40 (or the associated fluid passages 43) is related to the spreading characteristics (surface tension) and the viscosity of the fluid. For a given rate of deposition (e.g., a function of substrate velocity and pumping speed of the fluid in a horizontal set-up) the fluid passages 43 could be located further apart as the surface tension and viscosity decrease. When tested at room temperature, a fluid feed rate of 1 ml/min was obtained from a positive displacement pump, and it was thought to be preferable that the fluid feed rate be kept constant at that rate. Other fluid feed rates and delivery schemes also could be used. For example, by modifying the control of the flow rate, a thickness gradient in the applied fluid can be obtained.

Devices employing the present invention may be fitted with a closed loop feedback controller in order to compensate for changes in the meniscus shape. Such a controller could monitor an image corresponding to a cross-section of the meniscus, during the coating process, by using an optical imager. The image could be compared to a desired reference shape, e.g., a meniscus shape as observed at the start of the coating process. Of course, other images could be used, such as image formed in an optimized prior test, or even be a hypothetical image reflecting an idealized coating situation.

To facilitate the comparison of images it is preferable to digitize the images, so that a suitably programmed computer could compare such images. The coating fluid flow can be continuously adjusted to keep the deviation between the two shapes to a minimum, contributing to the production of uniform coatings. It is envisioned that videocameras connected to imaging processing devices such as frame grabbers could be used to control fluid flow, and such devices are currently available from Kodak and Sierra Scientific.

Examples of optical sensors which could be used in this embodiment of the invention could include devices which operate using interferometry, or devices which are position sensitive. Sensors also could be used to monitor the thickness of the wet film deposited immediately after leaving the die and provide information allowing feedback control of the pump and other system components. It is contemplated that such sensors could be laser displacement sensors or CCD laser scan micrometer devices of the type manufactured by Keyence Corp. of America, Woodcliff Lake, N.J.

In addition, mechanisms could be mounted along with the meniscus former or separately therefrom to assist in drying and/or curing of the coatings. One could provide a constant flow of air, inert gas or other gas over the coated area. Coating also could be carried out in a particular atmosphere. This could induce a constant flow of air, inert gas or other gas over the coated area, and also could help in removing volatile material, which would be carried away by the gas stream, e.g., to an exhaust or volatile matter recovery device. The gas flow composition could be used to control the atmosphere over the coated area either to prevent or to promote reactions that take place, for example, those which arise due to the presence of moisture or oxygen, or due to an acid or base catalyzed mechanism. For example, at least one of ammonia and water countering gas streams could interact with coatings produced from alkoxides or other precursors to promote reactions in the coated area. In addition to these aids, radiation sources could be used to assist in the processing of the coatings that are being deposited. Such radiations sources include infrared energy, ultraviolet energy, microwave energy, etc.

Prior art slot coating technology, because of the design of slot coating dies, was limited in applicability to the coating of webs and flat solid substrate, which are essentially planar in shape.

The present invention, however, is not so limited. In the case of a substrate having cylindrical symmetry (only one radius of curvature), it is possible to envision a die having a curved slit matching the curvature of the substrate and which can be used to coat along the length of the object. Alternatively, a flat head could be positioned along the length of the cylindrical axis of the object and the substrate moved around the center of curvature.

In the case of substrates having compound curvature, forming a constant meniscus requires that a constant geometrical relationship be maintained between the substrate and the dispensing head. Thus, another aspect of this invention concerns the provision of a dispensing head which can accommodate such demands and enable the coating of curved substrates.

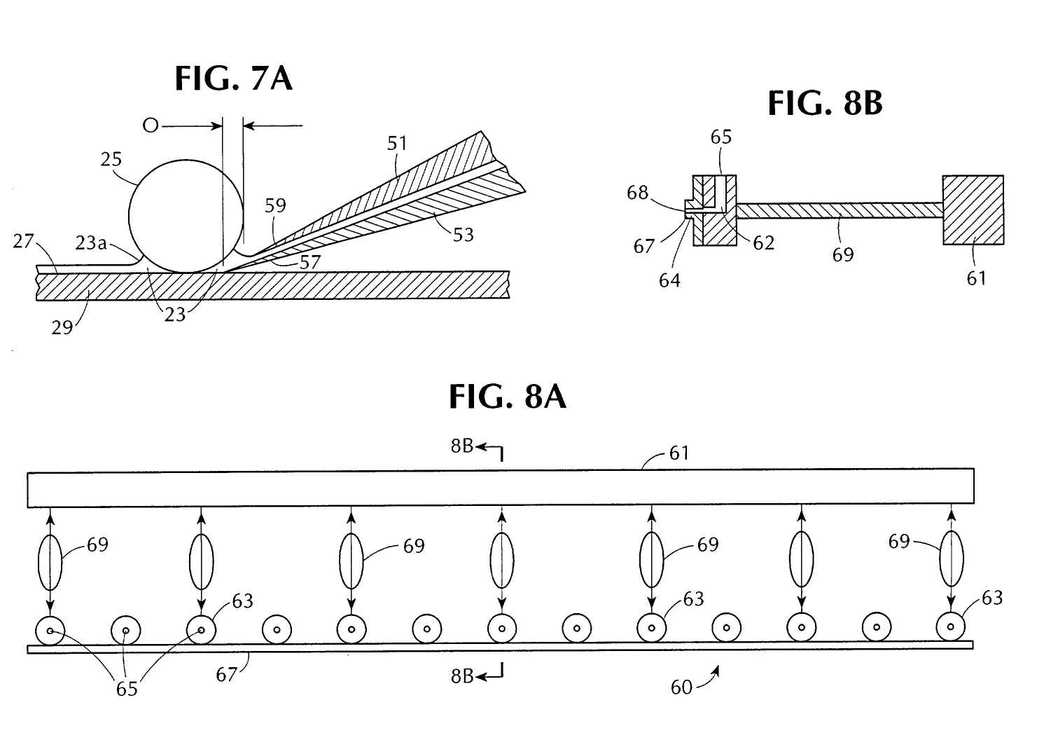

One embodiment of a flexible head which can coat both planar and non-planar objects is depicted in FIGS. 8A and 8B. This embodiment is intended for use in coating surfaces held approximately perpendicular to the ground. Of course, other orientations could be employed without departing from this invention.

The head takes the form of a series of dispensing units 63 disposed at predetermined intervals, each dispensing unit having an inlet orifice 65 through which coating fluid is introduced. As shown in FIG. 8B, the inlet orifices 65 are located on a surface of the head, and each inlet orifices communicates, via an internal passage 62 having a bend, with an associated fluid outlet orifice 64 formed in a channel plate 67, which is sufficiently flexible to enable it to conform to the substrate being coated, in the manner discussed below. The dispensing units 63 can be attached to the channel plate 67 in any conventional manner. It will be understood that a wide variety of different orifice and passage dimensions could be used when practicing this invention.

Channel plate 67, as shown in FIG. 8B, is an approximately rectangular structure having a groove 68 running along its length. Fluid leaving each dispensing unit 63 via fluid outlet orifices 64 enters the groove 68, and overflows therefrom, forming a meniscus between the substrate and the plate 67. This allows a regular film of coating liquid to be deposited.

The shape of the flexible channel plate 67 can be varied as follows. A sturdy, invariant, reference surface 61 runs in a direction approximately parallel to the plane of the surface being coated. Each dispensing head 63 is connected to an associated actuator unit 69, which in turn are all joined to reference surface 61. These actuators can be driven by a controller (not shown) to elongate or contract as required, so that the dispensing heads 63 are moved toward or away from the invariant reference surface. As previously explained, channel plate 67 is flexible, and so the shape of the channel plate, and groove 68 formed therein, varies as the head flexes. This way the profile of the channel plate can be controlled to an extent never before possible. Moreover, since the control of the head shape can be dynamic, the head shape can change as the substrate and head move past one another. Thus, non-planar shapes can be coated with precision.

The shape of the head 60 can be controlled using proximity sensors (not shown) to measure the contour of the substrate being coated, and the head shaped accordingly. Alternatively, a previously programmed routine could be implemented under machine control, so that the head is continuously flexed to follow the changing contour of the substrate. Such a head could be also used to coat flat or cylindrical substrates, in order to compensate for any surface non-uniformities.

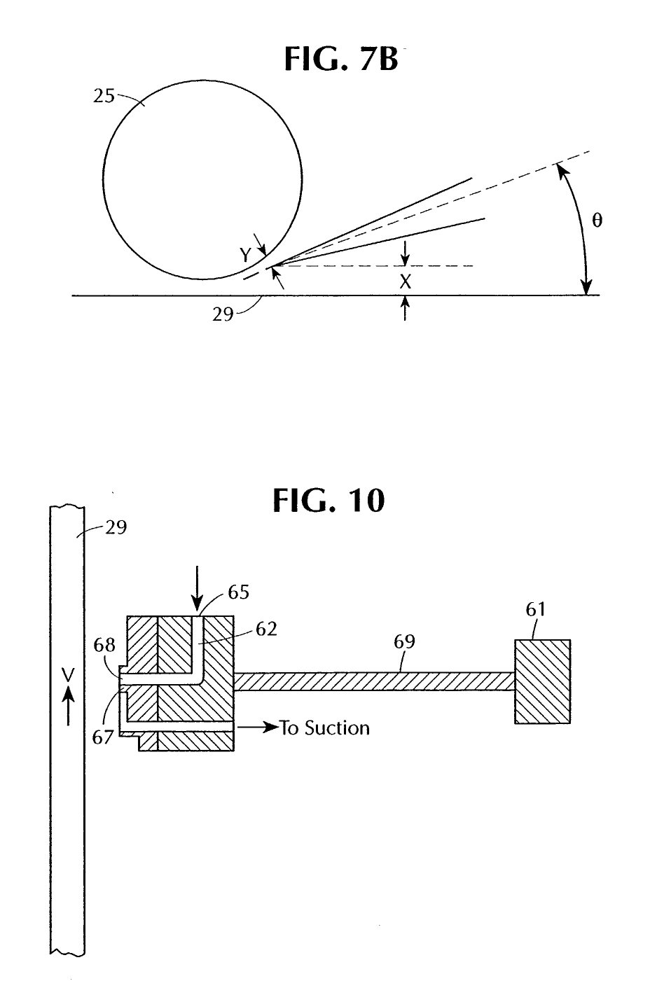

A preferred technique for coating curved substrates involves directly extruding the coating fluid onto the substrate in the vertical mode, i.e., keeping the meniscus in a horizontal plane during the entire coatings process. FIGS. 9A-C depict an especially preferred embodiment of the invention which can accomplish this goal. Die 66 is designed for such vertical use, and is similar in principle to the internally-branched flat die shown earlier in FIGS. 4A, 4B, 5A and 5B, and discussed in connection therewith. Die 66 could be formed from either a single piece of material, a piece of material having suitable grooves formed therein and joined to a matching flat cover plate, or two matching halves, each having the necessary grooves formed therein and joined with those grooves in registry. The single piece head would have narrow flexible bridges joining the dispensing heads, while in the two-piece heads, either one or both of the halves could have narrow flexible bridges 74 which connect the dispensing heads 63. Alternatively, the individual dispensing heads could be separately formed, and joined together by flexible webs of material.

FIGS. 9A-C depict a particularly preferred embodiment of this invention which utilizes the concepts discussed previously in connection with FIGS. 4A, 4B, 5A and 5B. Here, one part of the die 66 contains a number of different dispensing portions 63, each of which contains branching fluid passages 43 which transport coating liquid coming from a coating fluid supply source (not shown) to fluid outlet orifices 70 which lead to slot 72. The branched fluid passages consist of both advance legs 45 and transverse legs 43, which are shown as being approximately perpendicular to one another (of course, other configurations could be used). As with the embodiment depicted in FIGS. 4, 5 and 6, these branched passages serve to distribute the coating fluid uniformly.

Coating fluid leaves the fluid outlet orifices and enters the slot 72 formed in die 66. Other constructions resulting in this slot could be used, such as a single channel plate having a slot formed therein.

The variable (flex) geometry of this head is achieved by properly partitioning the head in sections, and connecting those sections by flexible webs.

The two halves of the die can be held together by small screws on each section, but other suitable known assembly schemes also could be used. Liquid can be fed through the top or bottom parts of each section. The whole bottom or top part of the head can be a single unit, and each section is connected to the next section by a thin and flexible bridge 74 designed in such a way that the head can be elastically deformed through the application of appropriate adequate forces. The number of sections per unit length will depend upon the size and shape of the substrate to be coated. The shape of this head can be controlled in the same manner as the previous embodiment depicted in FIGS. 8A and 8B.

If desired, the profile of the foregoing two flexible heads can be made such that in the equilibrium state where no forces are applied to the head the head shape matches the average profile of the substrate, thereby minimizing the amount of bending that will be required. To conform to the substrate during coating, corrective forces are applied to each section of the head by actuators. These in turn are attached to an invariant reference frame. The necessary information for head shape correction can be fed to a controller prior to actual coating if the geometry of the substrate is known, or head shape can be controlled in real time during coating by using distance sensors to gauge the substrate contour, or by monitoring the coating fluid profile and adjusting the head shape accordingly.

Either the head or the substrate can be moved during coating. Additionally, the substrate can be moved so that a plane tangent to the coating line is vertical at all times, and this can be done for both concave and convex substrates. In addition, the coating heads could contain ports or slots (not shown). Such ports or slots could be parallel to the dispensing slot, but of course other shapes might be used as well. These ports or slots could be used to suck away excess coating fluid, thereby avoiding dripping, remove any volatile matter from the coated area or otherwise facilitate drying and curing mechanisms, for example, by allowing gas flow, or the application of heat and radiation from the appropriate sources. These considerations can be incorporated to coat both flat and curved substrates.

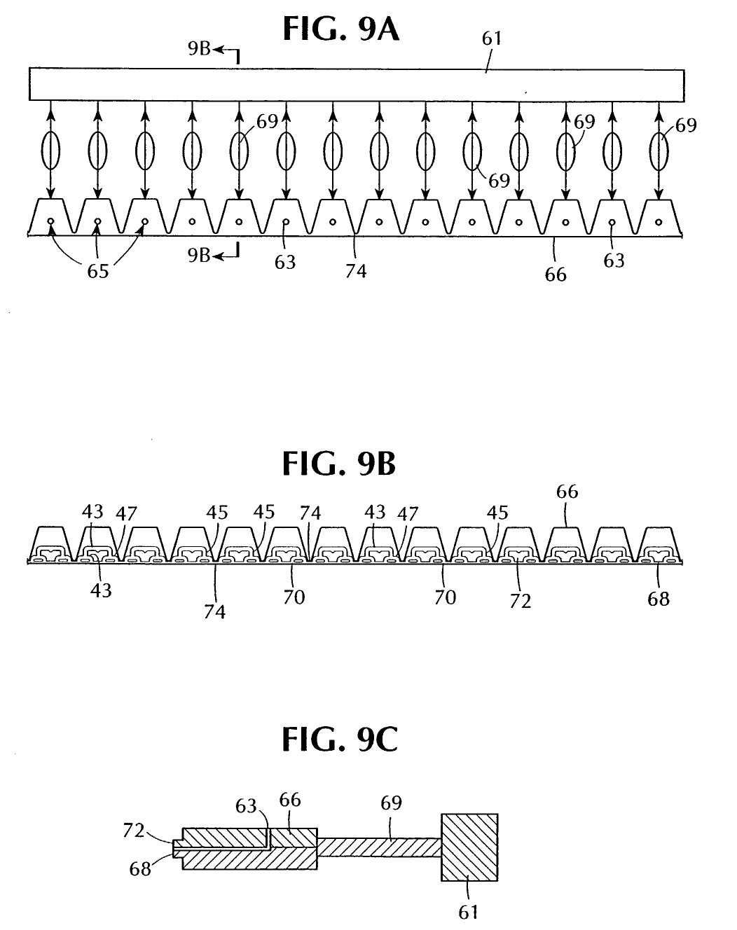

Still another example of a head which can be bent is shown in FIG. 10. As shown in this side cross-sectional view, the dispensing head has two slots. One of those slots, e.g., the upper one, can be used to dispense coating fluid onto the substrate. That slot is fed through a number of holes on the back. In contrast to the earlier designs, in this case the dispensing head is separated from the distribution manifold. In this design it is necessary to feed each of the holes with fluid at the same rate. This, e.g., can be done by using flexible tubing that are of equivalent geometry and are fed from a common reservoir. If desired, the lower slot could be used to suck away any excess fluid from the coating area. The holes behind this slot could be connected to a vacuum section. Either this slot or another slot below this one could be used to dry or cure the coating by applying heat, hot air or otherwise provide a mechanism to remove the volatiles from the coated areas.

In the preferred embodiments described above for coating a curved substrate, no separate meniscus former is used. It is, however, possible to design systems where a flexible meniscus former is used.

It will be appreciated that each of the aforementioned die and head structures can be fabricated using any of the various construction techniques which are known to those skilled in the art, and such structures would fall within the scope of the claimed invention. For example, while certain embodiments have been depicted as constituting upper and lower die plate members, alternative constructions in which the members are made from multiple plate could be used. Likewise, the lip structures for the heads could be integral to the die plates, or could be separate structures attached thereto.

Other variations and modifications of this invention will be apparent to those skilled in this art after careful study of this application. This invention is not to be limited except as set forth in the following claims.

What we claim is:

1. A liquid film die, comprising:
a body having
a slot;
a fluid inlet orifice;
a plurality of fluid outlet orifices communicating with said slot;
a plurality of fluid passages leading from said fluid inlet orifice through said body to said fluid outlet orifices, and defining a plurality of fluid paths thereby, each said fluid path having a fluid path geometry and leading from said fluid inlet orifice to an associated said fluid outlet orifice, all of said fluid path geometries being substantially equal.

2. A liquid film die according to claim 1, wherein said fluid passages lie in a plane.

3. A liquid film die according to claim 2, wherein said fluid outlet orifices are disposed on a straight line.

4. A liquid film die according to claim 2, wherein said fluid outlet orifices are disposed on a curved line.

5. A liquid film die according to claim 2, wherein said slot is a straight line.

6. A liquid film die according to claim 2, wherein said slot is a curved line.

7. A liquid film die according to claim 2, wherein said die has a width, and wherein said fluid passages comprise:
a plurality of transverse legs running approximately parallel to said width; and
a plurality of advance legs,
wherein said transverse legs are at least approximately perpendicular to said advance legs.

8. A liquid film die, comprising:
a first member having
a recess;
a fluid inlet orifice;
a plurality of fluid outlet openings communicating with said recess;
a plurality of fluid channels leading from said fluid inlet orifice to said fluid outlet openings; and
a second member joined to said first member so that said fluid channels define a plurality of fluid paths thereby, each said fluid path having a fluid path geometry and leading from said fluid inlet orifice to an associated said fluid outlet opening, all of said fluid path geometries being substantially equal, and wherein when said first and said second members are joined, they define a slot and a plurality of fluid orifices.

9. A liquid film die according to claim 8, wherein said fluid paths lie in a plane.

10. A liquid film die according to claim 9, wherein said fluid outlet orifices are disposed on a straight line.

11. A liquid film die according to claim 9, wherein said fluid outlet orifices are disposed on a curved line.

12. A liquid film die according to claim 9, wherein said slot is a straight line.

13. A liquid film die according to claim 9, wherein said slot is a curved line.

14. A liquid film die according to claim 9, wherein said die has a width, and wherein said fluid passages comprise:
a plurality of transverse legs running approximately parallel to said width; and
a plurality of advance legs,
wherein said transverse legs are at least approximately perpendicular to said advance legs.

15. A liquid film die, comprising:
a first member having
a fluid inlet orifice;
a plurality of fluid outlet openings;
a plurality of fluid channels leading from said fluid inlet orifice to said fluid outlet openings; and
a second member joined to said first member so that said fluid channels define a plurality of fluid paths thereby, each said fluid path having a fluid path geometry and leading from said fluid inlet orifice to an associated said fluid outlet opening, all of said fluid path geometries being substantially equal, and wherein when said first and said second members are joined, they define a plurality of fluid orifices.

16. A liquid film die, comprising:
a first member having
a first recess;
a fluid inlet orifice;
a plurality of first fluid outlet openings communicating with said first recess;
a plurality of first fluid channels leading from said fluid inlet orifice to said first fluid outlet openings;
a second member having
a second recess;
a plurality of second fluid outlet openings communicating with said second recess;
a plurality of second fluid channels leading from a point to said second fluid outlet openings;
wherein said second member is joined to said first member in a manner such that said first and said second recesses, said first and said second fluid outlet openings, and said first and said second fluid channels all are in registry and thereby define a plurality of fluid paths, each said fluid path having a fluid path geometry and leading from said fluid inlet orifice, which fluid paths are in registry, to associated said first and said second fluid outlet openings, which are in registry, and providing for fluid communication therebetween, all of said fluid path geometries being substantially equal, and wherein when said first and said second members are joined, they define a slot and a plurality of fluid orifices.

17. A liquid film die according to claim 16, wherein said closed fluid channels lie in a plane.

18. A liquid film die according to claim 17, wherein said fluid outlet openings are disposed on a straight line.

19. A liquid film die according to claim 17, wherein said fluid outlet openings are disposed on a curved line.

20. A liquid film die according to claim 17, wherein said slot is a straight line.

21. A liquid film die according to claim 17, wherein said slot is a curved line.

22. A liquid film die according to claim 17, wherein said die has a width, and wherein said first and said second fluid passages each comprise:
a plurality of transverse legs running approximately parallel to said width; and
a plurality of advance legs,
wherein said transverse legs are at least approximately perpendicular to said advance legs.

23. A liquid film die, comprising:
a first member having
a fluid inlet orifice;
a plurality of first fluid outlet openings;
a plurality of first fluid channels leading from said fluid inlet orifice to said first fluid outlet openings;
a second member having
a plurality of second fluid outlet openings;
a plurality of second fluid channels leading from a point to said second fluid outlet openings;
wherein said second member is joined to said first member in a manner such that said first and said second fluid outlet openings and said first and said second fluid channels all are in registry and thereby define a plurality of fluid paths, which fluid paths are in registry, each said fluid path leading from said fluid inlet orifice to associated said first and said second fluid outlet openings and having a fluid path geometry, which openings are in registry so as to define a plurality of fluid orifices, and providing for fluid communication therebetween, all of said fluid path geometries being substantially equal.

24. A fluid distribution process for applying a film of a fluid to a substrate, comprising the steps of:
providing a source of the fluid;
providing a number of fluid outlets and a slot-shaped landing area which are dimensioned and disposed so that when the fluid flows therefrom the fluid flows as a continuous film;
dividing, a plurality of times, the fluid coming from said source, to obtain a series of divided flows, equal in amount to the number of fluid outlets, each divided flow having a flow geometry, wherein said flow geometries all are substantially equal; and
guiding said divided flows to said fluid outlets, so as to form said continuous film.

25. A fluid film applicator for applying a film of a fluid onto a substrate, comprising:
a dispensing head which dispenses the fluid so that the fluid is deposited as a continuous sheet on the substrate; and
a meniscus forming member that controls a thickness of the fluid in the continuous sheet so as to form said film.

26. A fluid film applicator for applying a film of a fluid onto a substrate, said applicator and the substrate having a relative motion therebetween, comprising:
a dispensing die which dispenses the fluid so that the fluid is deposited as a continuous sheet on the substrate along a line; and
a meniscus forming rod having an axis approximately parallel to said line, said meniscus forming member being disposed proximate to said dispensing head,
wherein the fluid dispensed from said dispensing die forms an upstream meniscus and a downstream meniscus relative to the relative motion between the substrate and the fluid film applicator.

27. A fluid film applicator according to claim 26, wherein said meniscus forming rod is a wire-wound rod.

28. A fluid film applicator according to claim 26, wherein said meniscus forming rod is a smooth rod.

29. A fluid film applicator according to claim 24, wherein said meniscus forming rod rotates about said axis.

30. A fluid film applicator according to claim 24, wherein said dispensing head comprises:
an upper plate having a first edge; and
a lower plate having a second edge, said upper plate being separated from said lower plate so as to define a fluid channel therebetween,
wherein said first edge is offset backward from said second edge relative to a direction in which the fluid flows, and the fluid flows through said channel and emerges along the line.

31. A fluid distribution process for applying a film of a fluid to a substrate, comprising the steps of:
providing a source of the fluid;
providing a number of fluid outlets dimensioned and disposed so that when the fluid flows therefrom the fluid flows as a continuous film;
dividing, a plurality of times, the fluid coming from said source, to obtain a series of divided flows, equal in amount to the number of fluid outlets, each divided flow having a flow geometry, wherein said flow geometries all are substantially equal;
guiding said divided flows to said fluid outlets, so as to form said continuous film;
controlling a thickness of said continuous film on the substrate after said continuous film has been deposited on the substrate.

32. A fluid film applicator for applying a film of a fluid onto a substrate, said applicator and the substrate having a relative motion therebetween, comprising:
a dispensing head which dispenses the fluid so that the fluid is deposited as a continuous sheet along a line on the substrate, said dispensing head comprising;
an upper plate having a first edge; and
a lower plate having a second edge, said upper plate being separated from said lower plate so as to define a fluid channel therebetween,
wherein said first edge is offset backward from said second edge relative to a direction in which the fluid flows, and the fluid flows through said channel and emerges along the line;
a liquid film die, having,
a fluid inlet orifice;
a plurality of fluid outlet orifices communicating with said fluid channel;
a plurality of fluid passages leading from said fluid inlet orifice to said fluid outlet orifices, and defining a plurality of fluid paths thereby, each said fluid path having a fluid path geometry and leading from said fluid inlet orifice to an associated said fluid outlet orifice, all of said fluid path geometries being substantially equal; and
a meniscus forming rod having an axis approximately parallel to said line, said meniscus forming member being disposed proximate to said dispensing head,
wherein the fluid dispensed from said dispensing head forms an upstream meniscus and a downstream meniscus relative to the relative motion between the substrate and the fluid film applicator.

33. A liquid film die, comprising:
a reference body;
a deformable channel member having a groove;
a plurality of fluid dispensers for dispensing a coating fluid into the groove, said fluid dispensers being connected to one another by a plurality of flexible sections; and
a plurality of actuators corresponding in number to said fluid dispensers, each said fluid dispenser being connected to said reference body by an associated said actuator.

34. A liquid film die according to claim 31, wherein at least a portion of each said fluid dispenser and said flexible sections are integrally formed from a single piece of material.
